(19) United States
(12) Patent Application Publication
(10) Pub. No.: US 2019/0267711 A1
(43) Pub. Date: Aug. 29, 2019

(54) ANTENNA WITH FREQUENCY SELECTIVE SURFACE

(71) Applicant: THE CHARLES STARK DRAPER LABORATORY, INC., Cambridge, MA (US)

(72) Inventors: Jonathan Michael O'Brien, Cambridge, MA (US); Phillip Bradford Hulse, Cambridge, MA (US); Isaac Mayer Ehrenberg, Cambridge, MA (US)

(21) Appl. No.: 16/287,269

(22) Filed: Feb. 27, 2019

Related U.S. Application Data
(60) Provisional application No. 62/636,272, filed on Feb. 28, 2018.

(51) Int. Cl. H01Q 5/307; H01Q 21/06

(52) U.S. Cl. CPC H01Q 5/307; H01Q 21/065

(57) ABSTRACT

Examples include multi-band antenna systems and methods of operating same. In one example an antenna system includes a radiating element configured to receive and transmit electromagnetic energy at a first frequency and a second frequency, and a frequency selective surface positioned in proximity to the radiating element and configured to reflect the electromagnetic energy at the first frequency and to pass the electromagnetic energy at the second frequency.

### CROSS-REFERENCE TO RELATED APPLICATIONS

This application claims the benefit under 35 U.S.C. § 119(e) of co-pending U.S. Provisional Application No. 62/636,272 filed on Feb. 28, 2018 and titled “ANTENNA WITH FREQUENCY SELECTIVE SURFACE,” which is herein incorporated by reference in its entirety for all purposes.

### BACKGROUND

Antennae, antenna systems, and radiating elements are used in various applications to radiate, or transmit, electromagnetic energy at various frequencies or frequency bands, for various purposes such as communication, ranging, inspection, probing, testing, and other applications. In some cases, a grounding element, such as a ground plane, is used to increase the broadside gain from a radiating element. A ground plane is typically positioned a quarter wavelength (λ/4) from the radiating element to enhance radiation in a broadside direction. Enhanced radiation in the broadside direction, e.g., a direction away from the element and normal to the ground plane, is based upon resonant constructive reinforcement by reflected electromagnetic energy from the ground plane. Accordingly, the ground plane limits the frequency range or band for which broadside enhancement is exhibited. It would be beneficial to achieve similar results for a radiating element capable of supporting two or more frequencies and/or frequency bands.

### SUMMARY OF INVENTION

Aspects and embodiments are directed to antenna systems and methods that incorporate a frequency selective surface to provide selective reflection and/or ground plane characteristics, thereby allowing the antenna system or method to suitably operate at two or more frequencies or frequency bands.

According to one embodiment, an antenna system comprises a radiating element configured to receive and transmit electromagnetic energy at a first frequency and a second frequency, and a frequency selective surface positioned in proximity to the radiating element and configured to reflect the electromagnetic energy at the first frequency and to pass the electromagnetic energy at the second frequency.

In one example, the frequency selective surface is planar.

The antenna system may further comprise a ground element positioned in proximity to the radiating element and configured to reflect the electromagnetic energy at the second frequency. In one example, first frequency is greater than the second frequency, the frequency selective surface is positioned a first distance from the radiating element, the ground element is positioned a second distance from the radiating element, and the second distance is greater than the first distance such that the frequency selective surface is positioned between the radiating element and the ground element. In one example, the radiating element lies in a plane and each of the frequency selective surface and the ground element is planar and parallel to the plane in which the radiating element lies. In another example, the antenna system further comprises a first dielectric material disposed between the radiating element and the frequency selective surface, the first dielectric material having a first permittivity, the frequency selective surface being positioned a first distance from the radiating element that is a quarter of a wavelength of the first frequency in the first dielectric material. The antenna system may further comprise a second dielectric material disposed between the frequency selective surface and the ground element, the second dielectric material having a second permittivity, the ground element being positioned a second distance from the frequency selective surface, the first distance and the second distance together being a quarter of a wavelength of the second frequency when the electromagnetic energy of the second frequency travels sequentially through each of the first dielectric material and the second dielectric material. In another example, the antenna system further comprises at least one additional frequency selective surface positioned between the radiating element and the ground element.

In one example, the frequency selective surface is a first frequency selective surface, and further comprising a second frequency selective surface configured to selectively reflect the electromagnetic energy at the second frequency, the first frequency selective surface being positioned between the radiating element and the second frequency selective surface.

According to another embodiment, a method of radiating electromagnetic energy comprises providing electromagnetic energy at a first frequency, providing electromagnetic energy at a second frequency, reflecting the electromagnetic energy at the first frequency from a frequency selective surface, and transmitting the electromagnetic energy at the second frequency through the frequency selective surface.

In one example, the method further comprises reflecting the electromagnetic energy at the second frequency from a ground element.

In another example, the method further comprises providing electromagnetic energy at a third frequency and transmitting the electromagnetic energy at the third frequency through the frequency selective surface.

According to another embodiment, a method of receiving electromagnetic energy comprises reflecting electromagnetic energy at a first frequency from a first frequency selective surface, providing the reflected electromagnetic energy at the first frequency to a receiving element, and transmitting electromagnetic energy at a second frequency through the frequency selective surface.

The method may further comprise reflecting the electromagnetic energy at the second frequency from a further surface, and providing the reflected electromagnetic energy at the second frequency to the receiving element. In one example, the method further comprises reflecting electromagnetic energy at a third frequency from a second frequency selective surface, providing the reflected electromagnetic energy at the third frequency to the receiving element, and transmitting at least one of the electromagnetic energy at the first frequency and the electromagnetic radiation at the second frequency through the second frequency selective surface.

Still other aspects, embodiments, and advantages are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures may be represented by a like numeral. For purposes of clarity, not every component may be labeled in every figure. In the figures:

FIG. 1 is a schematic diagram of a radiating element with a reflective ground plane;

FIG. 2 is a graph of relative radiation power in a broadside direction for the radiating element of FIG. 1;

FIGS. 3A-3B are a pair of graphs of broadside gain for a leaf bowtie radiating element arranged with a reflective ground plane as in FIG. 1;

FIG. 4 is a schematic diagram of an example of an antenna system including a frequency selective surface;

FIG. 5 is a schematic diagram of the antenna system of FIG. 4 including details of an example of the frequency selective surface;

FIG. 6 is a graph of performance characteristics of an example of a frequency selective surface;

FIG. 7 is a graph of broadside gain of the antenna system of FIG. 5; and

FIGS. 8A-8B are 3-dimensional plots of far field radiation patterns of the antenna system of FIG. 5.

### DETAILED DESCRIPTION

Embodiments and examples disclosed herein are directed to antenna systems and methods that incorporate a frequency selective surface to provide selective reflection and/or ground plane characteristics, thereby allowing the antenna system or method to suitably operate at two or more frequencies or frequency bands.

Various radiating structure(s), element(s), or antenna(e), in accord with aspects and embodiments described herein include a frequency selective surface to act as a reflective surface at one frequency or frequency band and to act as a transmissive surface at another frequency or frequency band. For simplicity, the term “frequency” as used herein shall equally refer to a frequency band, being a range of frequencies around a frequency of interest, unless clearly indicated otherwise by the context. Accordingly, a frequency selective surface may act as a reflective ground plane for a first frequency (or frequency band) while being, in an ideal sense, transparent and/or effectively non-existent for a second frequency (or frequency band). In some embodiments, a secondary ground plane may act as a reflective surface for the second frequency, such that the frequency selective surface and the secondary ground plane each individually act as a reflective ground plane for each of the respective first and second frequencies. A radiating element positioned proximate the frequency selected surface and the ground plane may thereby operate with enhanced broadside gain in multiple frequencies, e.g., dual-band, by cooperative interaction with a frequency selective surface in a first frequency and by cooperative interaction with a secondary ground plane in a second frequency. In various embodiments, additional frequency selective surfaces and/or frequency-dependent properties of reflectivity and/or transmissivity of one or more frequency selective components may be incorporated to extend the principal to any number of frequencies (or frequency bands), e.g., to form a multi-band antenna.

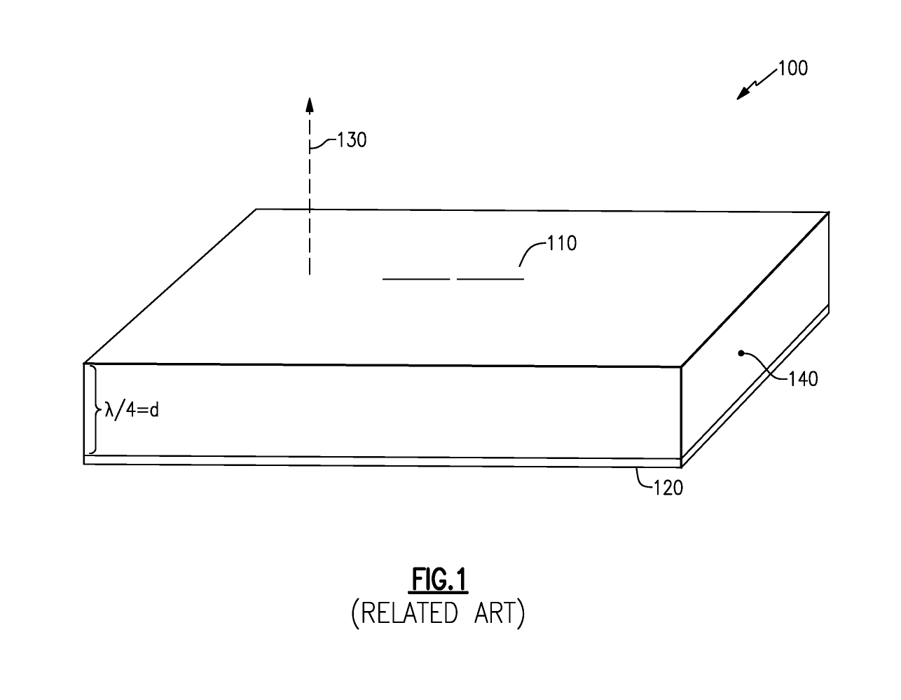

FIG. 1 illustrates a conventional configuration of an antenna system 100 that includes a radiating element 110 and a ground plane 120 set at a distance, d, from the radiating element 110. Some electromagnetic energy radiated from the radiating element 110 occurs in the broadside direction 130, away from and normal to the ground plane 120. Some electromagnetic energy radiated from the radiating element 110 occurs in the direction of the ground plane 120 and is reflected by the ground plane 120. If the ground plane 120 is appropriately positioned at a quarter wavelength distance, d=λ/4, from the radiating element 110, the reflected electromagnetic energy arrives back at the radiating element 110 in-phase with the electromagnetic energy being radiated in the broadside direction 130 and causes constructive reinforcement. As a result, the total electromagnetic energy radiated in the broadside direction 130 is approximately double, e.g., +3 dB, what it would be without the ground plane 120.

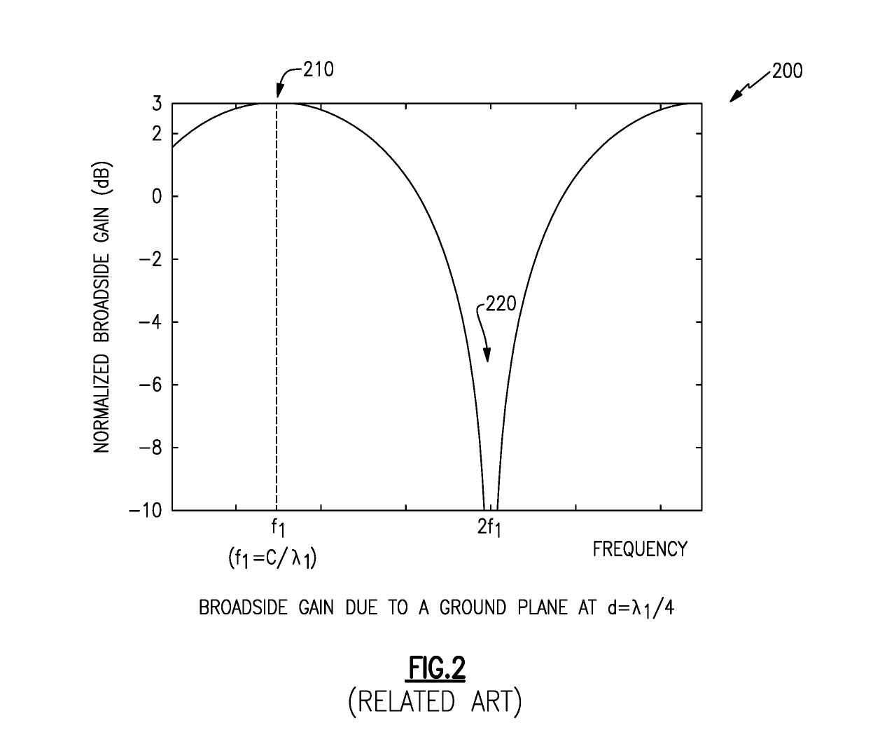

A selected positioning of the ground plane 120 at a quarter wavelength distance, d=λ/4, applies to a particular frequency, f=c/λ, where c is the speed of light in the dielectric material 140 between the radiating element 110 and the ground plane 120. A range of frequencies around the frequency, f, may also exhibit enhanced radiation strength in the broadside direction 130, while other frequencies may not exhibit enhanced radiation, or may exhibit diminished radiation in the broadside direction 130, e.g., due to destructive interference of reflected electromagnetic energy that is out-of-phase with the electromagnetic energy radiated from the radiating element 110 in the broadside direction 130, as discussed below with reference to FIG. 2. While a theoretical ground plane may be infinite in extent, practical embodiments include limited dimensions, and the term “ground plane” is not intended to indicate any particular dimension or extent, but rather any dimension or extent sufficient to provide a reflective surface that exhibits acceptable performance characteristics for a given application.

FIG. 2 illustrates a graph 200 of theoretical relative radiation intensity in the broadside direction 130 versus frequency, from the radiating element 110 accompanied by the ground plane 120, of FIG. 1. The radiation intensity shown in FIG. 2 is relative to that of a radiating element 110 in free space, e.g., without a nearby ground plane, regardless of the exact form of the radiating element 110. Accordingly, at the frequency f₁ for which the ground plane 120 is a quarter wavelength distant, d=λ₁/4, the broadside radiation intensity has a gain of 3 dB at point 210 of the graph 200. At other frequencies, however, the broadside gain is lower and in many cases is a broadside reduction. At twice the frequency, f₁, e.g., f₂=2×f₁, the ground plane 120 is a half wavelength distant, d=λ₂/2 (where λ₂ is the wavelength at frequency f₂), and the reflected electromagnetic energy from the ground plane 120 destructively interferes with electromagnetic energy radiated away from the ground plane 120 in the broadside direction 130. Accordingly, at the second frequency, f₂=2×f₁, there is severely reduced broadside radiation intensity, as shown at point 220 of the graph 200.

The results of the graph 200 of FIG. 2 are based upon theoretical analysis under ideal conditions; a real-world radiating element 110 with a nearby ground plane 120 may exhibit different results. For example, electromagnetic energy reflected directly back from the ground plane 120 toward the radiating element 110 experiences dispersion, absorption, etc., and may have a lower energy than the theoretical amount. Accordingly, a real broadside gain at frequency f₁ may be lower than 3 dB, and a real broadside reduction at frequency f₂=2×f₁ may not be as completely destructive as implied by the graph 200 of FIG. 2.

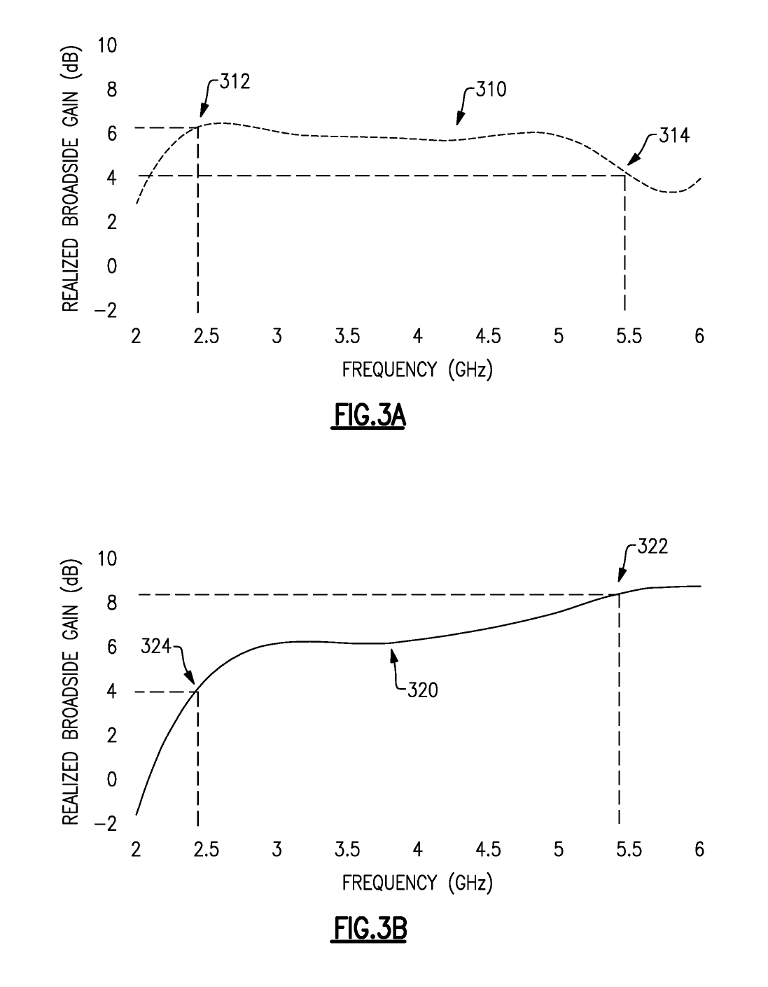

FIGS. 3A and 3B illustrate two examples of a broadside gain 310, 320 for a leaf bowtie radiating element in the presence of a nearby ground plane. The broadside gain 310 (FIG. 3A) illustrates results for a ground plane positioned to provide constructive reinforcement at 2.45 GHz, while the broadside gain 320 (FIG. 3B) illustrates results for a ground plane positioned to provide constructive reinforcement at 5.45 GHz. Each of the broadside gains 310, 320 may be relative to a normalized point source, for example.

With reference to the broadside gain 310 shown in FIG. 3A, the ground plane may be positioned at a distance that is approximately d=30.6 mm away (e.g., a quarter wavelength at 2.45 GHz), with an intervening material having a relative permittivity of one. Accordingly, the broadside gain 310 exhibits a relatively high value at point 312, corresponding to the quarter-wave frequency of 2.45 GHz. At a higher frequency of 5.45 GHz, however, the broadside gain 310 exhibits diminished performance, e.g., at point 314.

With reference to the broadside gain 320 shown in FIG. 3B, the ground plane may be positioned at a distance of approximately d=13.75 mm away (e.g., a quarter wavelength at 5.45 GHz). Accordingly, the broadside gain 320 exhibits a relatively high value at point 322, corresponding to the quarter-wave frequency of 5.45 GHz. At the lower frequency of 2.45 GHz, however, the broadside gain 320 exhibits diminished performance, e.g., at point 324.

As illustrated by FIGS. 3A and 3B, a single ground plane provides enhanced broadside radiation intensity for a particular frequency but may produce diminished performance at other frequencies. For example, a radiating element desired to operate as a dual-band radiator, such as the example of two frequencies, 2.45 GHz and 5.45 GHz, fails to achieve the maximum constructive reinforcement at each of the two frequencies. It is desirable to achieve the performance at point 322 with a relatively nearby ground plane for operation at 5.45 GHz while also achieving the performance at point 312 with a relatively more distant ground plane for operation at 2.45 GHz, for example. Accordingly, it is desirable to achieve the substantial equivalent of two or more ground planes, each operating to provide constructive reinforcement (to provide enhanced broadside gain) at a different frequency.

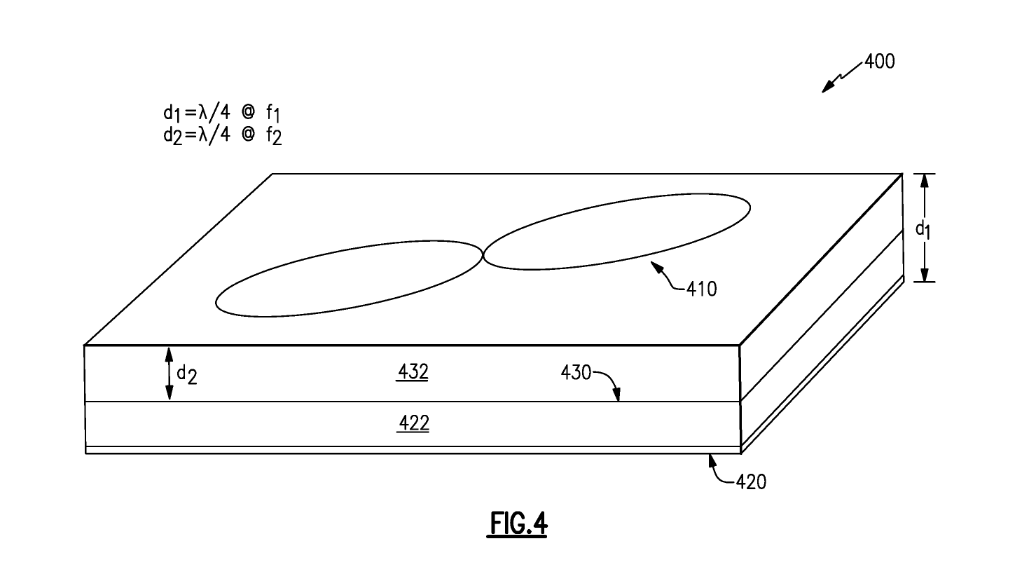

FIG. 4 illustrates an example of antenna system 400 in accord with aspects and embodiments described herein. The antenna system 400 includes a radiating element 410, a first ground plane 420, and a second ground plane 430. The radiating element 410 is shown as a leaf bowtie element, but may be any of various radiating structures in various embodiments. In various embodiments, the first ground plane 420 may be a solid ground plane of a conventional design, positioned at a first distance, d₁, from the radiating element 410. The first distance, d₁, may be selected, along with one or more relative permittivities of intervening material, to provide enhanced radiation intensity in a particular direction, such as but not limited to a broadside direction, at a first frequency. In various embodiments, the second ground plane 430 may be formed as a frequency selective surface being substantially transparent at the first frequency (e.g., having relatively high transmissivity for electromagnetic energy at the first frequency) and being substantially reflective at a second frequency. The second ground plane 430 is positioned at a second distance, d₂, from the radiating element 410. The second distance, d₂, may be selected, along with one or more relative permittivities of intervening material, to provide enhanced radiation intensity in a particular direction, such as but not limited to the broadside direction, at the second frequency. In some embodiments, one or more additional ground planes may be provided, positioned at various distances from the radiating element 410, and formed as one or more frequency selective surfaces, having various reflectivity and transmissivity at various frequencies, e.g., to provide enhanced radiation intensity at additional frequencies, such as for tri-band, quad-band, or higher number of bands of operating frequencies.

Accordingly, the antenna system 400 operates in such manner that the radiating element 410 substantially interacts with the first ground plane 420 when radiating electromagnetic energy of the first frequency, and substantially interacts with the second ground plane 430 when radiating electromagnetic energy of the second frequency. In various examples, the radiating element 410 may be operated to radiate electromagnetic energy at each of the first frequency and the second frequency simultaneously. Electromagnetic energy of the first frequency may be substantially allowed to pass through the second ground plane 430 and be reflected by the first ground plane 420. Electromagnetic energy of the second frequency, however, may be substantially reflected by the second ground plane 430 and not reach the first ground plane 420, for example.

In various embodiments, the first ground plane 420 and the second ground plane 430 may be separated by a first dielectric material 422, which may be different from a second dielectric material 432 between the second ground plane 430 and the radiating element 410. Accordingly, each of the first and second dielectric materials 422, 432 may have different permittivity. Nonetheless, the distances, d₁ and d₂, may be appropriately selected, e.g., to yield an overall quarter wavelength equivalent to the first and second ground planes 420, 430 at respective frequencies. Accordingly, in some embodiments, the selection of dielectric materials may be based on additional criteria, such as size, weight, strength, etc.

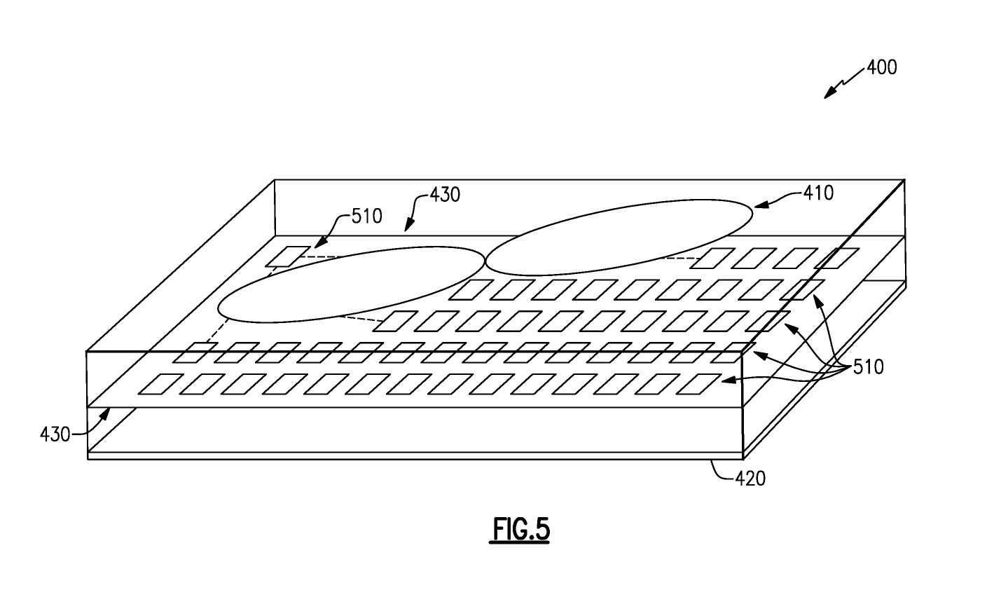

As described above, a frequency selective surface may be utilized in various embodiments to provide a surface that acts as a ground plane at one frequency but not at another frequency. Various frequency selective surface designs are known, and accordingly are not described in detail. However, FIG. 5 illustrates the antenna system 400, including the radiating element 410, the first ground plane 420, and at least one embodiment of a frequency selective surface as the second ground plane 430. The frequency selective surface making up the ground plane 430 in FIG. 5 is an example of a periodically spaced loop frequency selective surface, which includes a plurality of loop elements 510 periodically spaced in relative proximity to each other. The loop elements 510 may alternatively be termed unit cells in some instances. The loop elements 510 may, in some embodiments, be conductors of a rectangular or square shape, as shown, or may be triangular, round, hexagonal, or other shapes or combinations, in various embodiments. The loop elements 510 form an electrical loop, though non-looped shapes such as dipoles or crosses may also be used as unit cells in various embodiments. At least one advantage to a loop element, versus a dipole, is that a loop element may be polarization agnostic and thereby advantageous for some applications. In certain embodiments, reflective voltages within and between the loop elements 510 are enhanced by a circumference of each loop element 510 being approximately one wavelength and by tight spacing between the loop elements 510, such that the frequency selective surface exhibits enhanced reflectivity for the given wavelength.

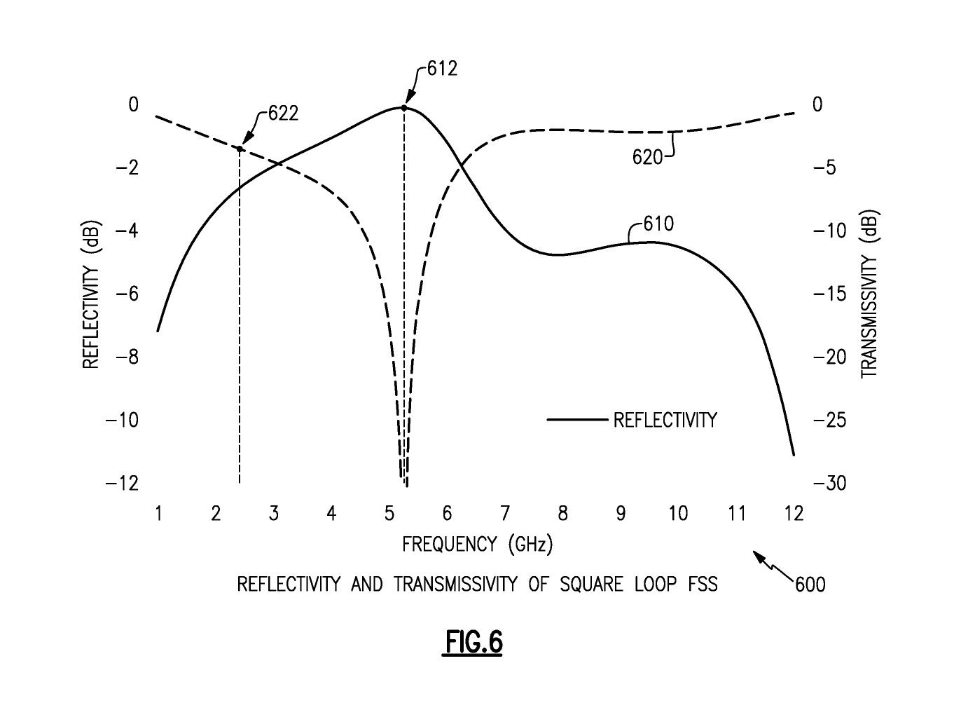

FIG. 6 shows a graph 600 that illustrates performance characteristics for an example of a frequency selective surface (FSS) formed of square loop elements, similar to the frequency selective surface shown as an example of the second ground plane 430 in FIG. 5 having loop elements 510. The graph 600 includes a trace 610 indicating a reflectivity, in dB, of the frequency selective surface, and a trace 620 indicating a transmissivity, in dB, of the frequency selective surface. The particular frequency selective surface exhibits a high reflectivity at point 612, occurring at a frequency of approximately 5.45 GHz, and may be particularly suitable to act as a ground plane for a frequency of 5.45 GHz.

A particular embodiment of an antenna system, in accord with aspects described herein, may be intended for dual-band operation at 5.45 GHz and at 2.45 GHz. Accordingly, a ground plane for the 5.45 GHz band, such as may be the frequency selective surface represented by FIG. 6, is advantageous if it also has significant transmissivity for the other band, at 2.45 GHz. The particular frequency selective surface provides a relativity high transmissivity at 2.45 GHz, exhibiting only about 1.5 dB of loss at 2.45 GHz, as indicated at point 622. Accordingly, the frequency selective surface represented by FIG. 6 may be particularly suitable for a dual-band antenna system to act as a ground plane at 5.45 GHz at a particular distance from a radiating element, while allowing electromagnetic energy at 2.45 GHz to pass through to interact with a ground plane further away from the radiating element, resulting in quarter wave interaction with the radiating element in both frequency bands, in at least one embodiment.

While examples disclosed herein refer to dual-band operation at 2.45 GHz and 5.45 GHz, various numbers of bands at various frequencies may be supported by selecting or designing frequency selective surfaces with various reflectivity and transmissivity at frequencies of interest. Accordingly, certain embodiments may provide dual-band operation at other frequencies and/or may provide multi-band operation at three or more frequencies.

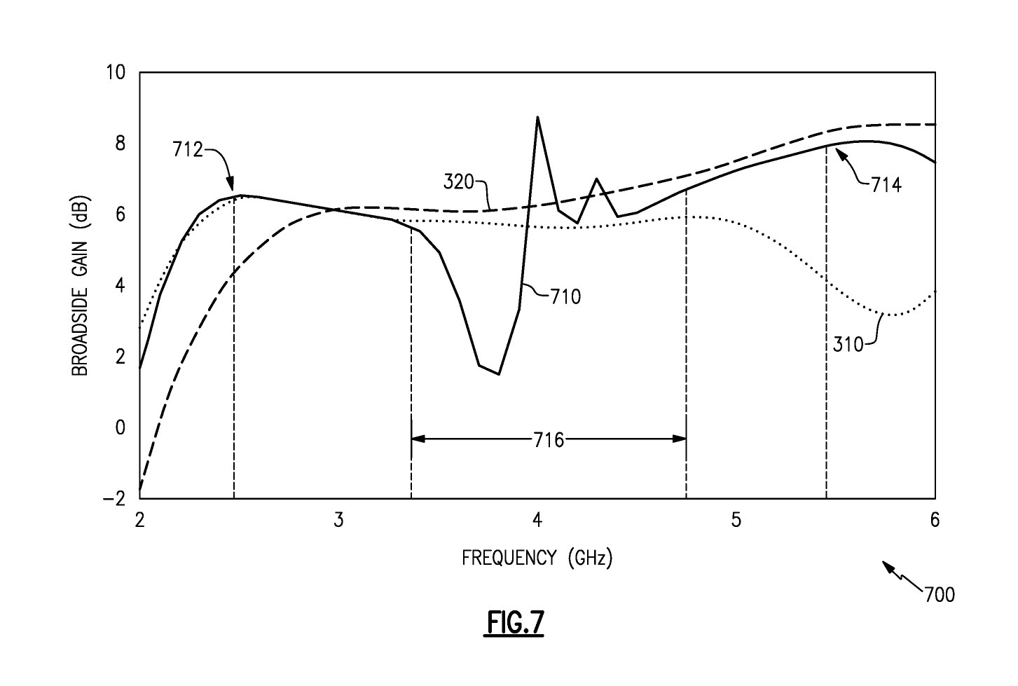

FIG. 7 shows a graph 700 that illustrates performance characteristics for an example of an antenna system similar to that of FIG. 5 with a frequency selective surface having characteristics similar to those shown in FIG. 6. The trace 710 represents the broadside gain of such an antenna system. For example, the first ground plane 420 is a solid copper cladding positioned a quarter wave (at 2.45 GHz) away from a radiating element 410 (accounting for permittivity of the dielectric materials 422, 432), and the second ground plane 430 is the frequency selective surface positioned a quarter wave (at 5.45 GHz) away from the radiating element 410 (accounting for permittivity of the dielectric material 432). The graph 700 includes, for reference, the broadside gains 310, 320 of FIG. 3 exhibited when a single ground plane is present at a 2.45 GHz quarter wave distance and at a 5.45 GHz quarter wave distance, respectively.

The resulting broadside gain illustrated by the trace 710 exhibits similar performance at 2.45 GHz (shown at point 712) as a single ground plane positioned for 2.45 GHz operation, and also exhibits similar performance at 5.45 GHz (shown at point 714) as a single ground plane positioned for 5.45 GHz. Accordingly, the antenna system performs well at both 2.45 GHz and at 5.45 GHz. At 2.45 GHz, the frequency selective surface is primarily transmissive (e.g., transparent) and the first ground plane 420 acts as a reflective ground plane providing reflected electromagnetic energy in-phase with the radiating element 410. At 5.45 GHz, the frequency selected surface is primarily reflective and itself acts as a reflective ground plane providing reflected electromagnetic energy in-phase with the radiating element 410. A transition region 716 illustrates various broadside gain results as the frequency selective surface exhibits varying levels of reflectivity and transmissivity in this region. The antenna system, however, is designed for dual-band operation at the frequencies presented, i.e., 2.45 GHz and 5.45 GHz, and operation in the transition region 716 is not significant. In some embodiments, operation in various regions may be controlled and/or designed by appropriate selection and/or design of the frequency selective surface. In various embodiments, three or more frequencies (or frequency bands) may be selected or designed by appropriate placement, selection, and/or design of one or more frequency selective surfaces.

Various frequency selective surfaces in accord with aspects and embodiments described herein may be designed to provide reflectivity at more than one frequency. Further, various frequency selective surfaces in accord with aspects and embodiments described herein may be designed with more or less regard to which frequencies are transmitted than reflected. For example, a frequency selective surface may be selected or designed for its transmissive performance over its reflective performance. Various embodiments may include frequency selective surfaces selected or designed to balance a reflective frequency range with a transmissive frequency range. Accordingly, various frequency selective surfaces may be of a highpass, lowpass, bandpass, bandstop, or other configuration. In addition, various frequency selective surfaces may be constructed of single layer or multiple layer designs.

In some embodiments, a frequency selective surface may be selected or designed to allow one frequency over another to pass through, e.g., to be substantially transparent, allowing through electromagnetic energy of that frequency to interact elsewhere or for some further desirable effect. For example, a frequency selective surface may be selected or designed to reflect a first frequency, e.g., to improve broadside gain as variously discussed above, while allowing a second frequency to pass through to be coupled to or interact with other elements, e.g., without regard for whether the passed second frequency interacts with another ground plane or is reflected in any other manner. Accordingly, various embodiments may include a frequency selective surface as a reflective component for one or more selected frequencies and/or as a transmissive component for one or more selected frequencies, without regard for other components (e.g., without regard for the existence of a solid ground plane acting as a solid reflective component).

In various embodiments, a “ground plane” may not be planar in a strict sense and may include other shapes, such as a cylindrical section, conical section, spherical section, or may conform to any particular shape or surface, as may be advantageously designed to provide various reflections and/or radiation patterns when placed in cooperative arrangement with a radiating element. Accordingly, one or more frequency selective surfaces, having various shape, to nominally provide reflective electromagnetic energy at one frequency while not at another, is in keeping with aspects and embodiments described herein even though the frequency selective surface may not be planar or flat.

Additionally, while embodiments have been described with a radiating element, various embodiments are equally functional as a receiving element, and in general may operate in a transmit or a receive mode at various times and/or simultaneously, in some examples. Accordingly, a frequency selective surface may be advantageously designed to provide various reflectivity and transmissivity to provide radiation and/or response patterns to electromagnetic energy at various frequencies, without departure from the aspects and embodiments described herein.

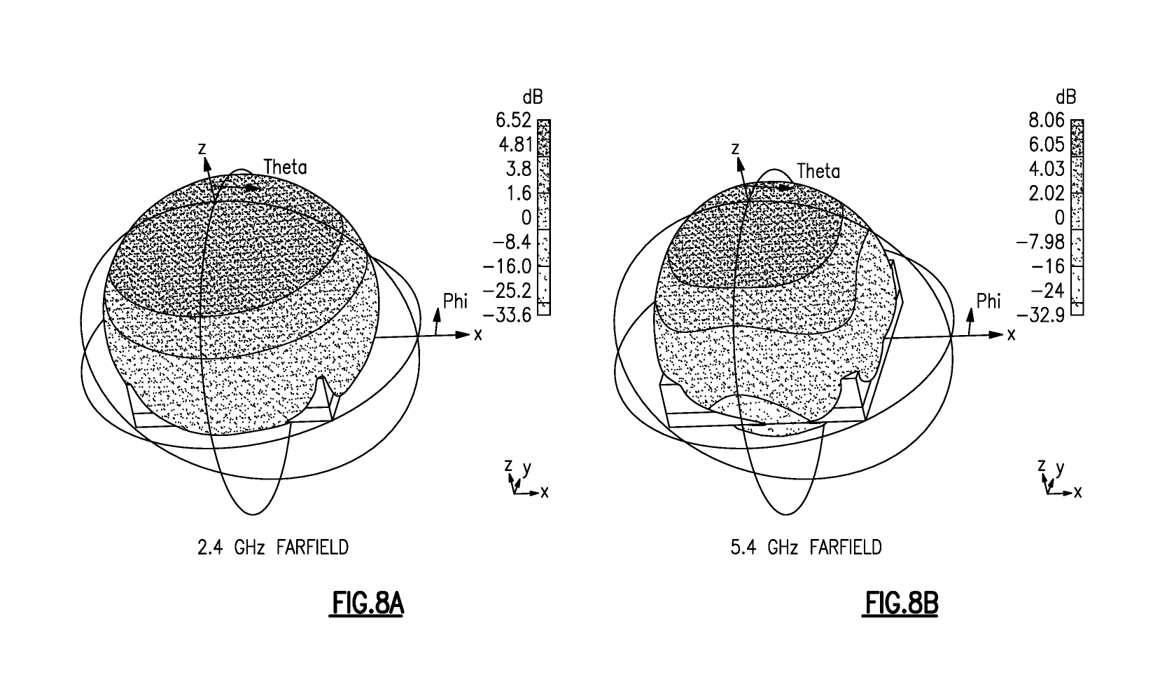

FIGS. 8A and 8B illustrate a resulting 3-dimensional far field pattern for the antenna system of FIG. 5 with a frequency selective surface having characteristics similar to those illustrated in FIG. 6, with the first and second ground planes 420, 430 appropriately positioned as described above. FIG. 8A illustrates the far field pattern (transmit or receive) of the antenna system at 2.4 GHz, while FIG. 8B illustrates the far field pattern (transmit or receive) of the antenna system at 5.4 GHz.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Various embodiments of the methods and apparatuses discussed herein are not limited in application to the details of construction and the arrangement of components set forth in the above descriptions or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation. Accordingly, the foregoing description and drawings are by way of example only, and the scope of the invention should be determined from proper construction of the appended claims, and their equivalents.

What is claimed is:

1. An antenna system comprising:
a radiating element configured to receive and transmit electromagnetic energy at a first frequency and a second frequency; and
a frequency selective surface positioned in proximity to the radiating element and configured to reflect the electromagnetic energy at the first frequency and to pass the electromagnetic energy at the second frequency.

2. The antenna system of claim 1 wherein the frequency selective surface is planar.

3. The antenna system of claim 1 further comprising a ground element positioned in proximity to the radiating element and configured to reflect the electromagnetic energy at the second frequency.

4. The antenna system of claim 3 wherein the first frequency is greater than the second frequency, the frequency selective surface is positioned a first distance from the radiating element, the ground element is positioned a second distance from the radiating element, and the second distance is greater than the first distance such that the frequency selective surface is positioned between the radiating element and the ground element.

5. The antenna system of claim 4 wherein the radiating element lies in a plane and each of the frequency selective surface and the ground element is planar and parallel to the plane in which the radiating element lies.

6. The antenna system of claim 3 further comprising a first dielectric material disposed between the radiating element and the frequency selective surface, the first dielectric material having a first permittivity, the frequency selective surface being positioned a first distance from the radiating element that is a quarter of a wavelength of the first frequency in the first dielectric material.

7. The antenna system of claim 6 further comprising a second dielectric material disposed between the frequency selective surface and the ground element, the second dielectric material having a second permittivity, the ground element being positioned a second distance from the frequency selective surface, the first distance and the second distance together being a quarter of a wavelength of the second frequency when the electromagnetic energy of the second frequency travels sequentially through each of the first dielectric material and the second dielectric material.

8. The antenna system of claim 3 further comprising at least one additional frequency selective surface positioned between the radiating element and the ground element.

9. The antenna system of claim 1 wherein the frequency selective surface is a first frequency selective surface, and further comprising a second frequency selective surface configured to selectively reflect the electromagnetic energy at the second frequency, the first frequency selective surface being positioned between the radiating element and the second frequency selective surface.

10. A method of radiating electromagnetic energy, the method comprising:
providing electromagnetic energy at a first frequency;
providing electromagnetic energy at a second frequency;
reflecting the electromagnetic energy at the first frequency from a frequency selective surface; and
transmitting the electromagnetic energy at the second frequency through the frequency selective surface.

11. The method of claim 10 further comprising reflecting the electromagnetic energy at the second frequency from a ground element.

12. The method of claim 10 further comprising providing electromagnetic energy at a third frequency and transmitting the electromagnetic energy at the third frequency through the frequency selective surface.

13. A method of receiving electromagnetic energy, the method comprising:
reflecting electromagnetic energy at a first frequency from a first frequency selective surface;
providing the reflected electromagnetic energy at the first frequency to a receiving element; and
transmitting electromagnetic energy at a second frequency through the frequency selective surface.

14. The method of claim 13 further comprising:
reflecting the electromagnetic energy at the second frequency from a further surface; and
providing the reflected electromagnetic energy at the second frequency to the receiving element.

15. The method of claim 14 further comprising:
reflecting electromagnetic energy at a third frequency from a second frequency selective surface;
providing the reflected electromagnetic energy at the third frequency to the receiving element; and
transmitting at least one of the electromagnetic energy at the first frequency and the electromagnetic radiation at the second frequency through the second frequency selective surface.
